(19) United States
(12) Patent Application Publication
(10) Pub. No.: US 2011/0121650 A1
(43) Pub. Date: May 26, 2011

(54) CIRCUIT CONFIGURATION AND METHOD FOR PROVIDING A VOLTAGE SUPPLY FOR A DRIVER CIRCUIT

(75) Inventors: MARTIN WEINMANN, BAD WALDSEE (DE); MARTIN RIESER, WANGEN (DE); ARTUR SCHÜTZ, WANGEN (DE)

(73) Assignee: DIEHL AKO STIFTUNG & CO. KG, WANGEN (DE)

(21) Appl. No.: 12/951,554

(22) Filed: Nov. 22, 2010

(30) Foreign Application Priority Data
Nov. 20, 2009 (DE) 10 2009 053 909
May 29, 2010 (DE) 10 2010 022 001

(51) Int. Cl. G05F 1/56

(52) U.S. Cl. 307/31

(57) ABSTRACT

A circuit configuration for providing a voltage supply for a driver circuit driven by a controller, contains a controller for driving a driver circuit, and an intermediate circuit for providing a DC voltage. The intermediate circuit is connectable to a voltage source. A first voltage regulating circuit is provided for generating an auxiliary voltage from the DC voltage. A second voltage regulating circuit is provided for generating a first supply voltage for the controller from the auxiliary voltage. A third voltage regulating circuit is provided for generating a second supply voltage for the driver circuit from the auxiliary voltage. In this case, the third voltage regulating circuit generates the second supply voltage in a manner dependent on a control signal from the controller.

### CROSS-REFERENCE TO RELATED APPLICATION

This application claims the priority, under 35 U.S.C. §119, of German application Nos. DE 10 2009 053 909, filed Nov. 20, 2009, and DE 10 2010 022 001, filed May 29, 2010; the prior applications are herewith incorporated by reference in their entirety.

### BACKGROUND OF THE INVENTION

### Field of the Invention

The present invention relates to a circuit configuration for providing a voltage supply for a driver circuit driven by a controller, and to a method for providing a voltage supply for a driver circuit driven by a controller.

Semiconductor switches, in particular power transistors for switching high currents and voltages, such as are used in a power semiconductor bridge for driving a motor, for example, often requires specific driver circuits for generating the control signals which control the switching-on and switching-off of the power transistors. In this case, the driver circuits are usually driven by a controller such as a microcontroller, for example.

Generally, a circuit configuration or electronic unit used for driving a motor requires a plurality of different supply voltages, which are predetermined by the components to be supplied. The requirements made of these supply voltages with regard to accuracy, ripple, loading capacity, etc. are as different as the required voltage levels. Thus, by way of example, a microcontroller typically requires a very accurate and loadable 3.3 V supply voltage, while peripheral components such as operational amplifiers, relays, drivers and the like require a 5-15 V supply voltage with an average accuracy requirement.

The energy for generating these supply voltages is often drawn from an intermediate circuit. Since each voltage level means circuit outlay and hence space requirement and costs, it is conventionally the case that usually only two different voltages are generated and continuously provided. They are typically 3.3 V for the microcontroller and 15 V for the remaining loads.

However, this concept has the now described disadvantages.

First, if the electronic unit is in the quiescent state, most of the loads which are connected with motor operation are not required, but nevertheless continue to load the supply voltage, which has to be continuously provided on account of other loads.

Second, some loads, such as some operational amplifiers, for example, have a variable voltage input of typically 5 to greater than 15 V and require a constant current independently of voltage. Therefore, it is disadvantageous with regard to the power loss to supply them with 15 V.

Third, the microcontroller configures its ports during power-up. Its outputs that drive the driver stage are possibly not defined in this time. If the supply voltage for the driver circuit is already present at this point in time, this can lead to undesirable switching-on of the power semiconductors.

Fourth, the larger auxiliary voltage of 15 V, for example, generated from the intermediate circuit supplies the peripheral components and serves as a source for the lower auxiliary voltage of, for example, 3.3 V for the controller. This lower supply voltage for the controller is generated from the larger auxiliary voltage by a series regulator, for example, which is highly lossy on account of the relatively large voltage difference.

Published, non-prosecuted German patent application DE 101 33 204 A1 describes a method for generating the supply voltage for driver circuits by coupling-out from the power section.

Published, non-prosecuted German patent application DE 10 2007 061 978 A1, corresponding to U.S. patent publication No. 20090160534, discloses a circuit configuration for providing a voltage supply for a plurality of driver circuits. This conventional circuit configuration contains a first bootstrap circuit having a first capacitor, to which a first auxiliary voltage is fed, and also a first charge pump for providing the voltage supply for the first driver circuit, a second bootstrap circuit having a second capacitor, to which a second auxiliary voltage is fed, for generating the input voltage for the first charge pump of the first bootstrap circuit, and a second charge pump for generating the second auxiliary voltage. While the input voltage of the first driver circuit is provided by the first bootstrap circuit, the second driver circuit is supplied directly by the first auxiliary voltage.

### SUMMARY OF THE INVENTION

It is accordingly an object of the invention to provide a circuit configuration and a method for providing a voltage supply for a driver circuit which overcome the above-mentioned disadvantages of the prior art methods and devices of this general type.

The circuit configuration according to the invention provides a voltage supply for a driver circuit driven by a controller. The circuit configuration contains a controller for driving the driver circuit, a first voltage regulating circuit for generating an auxiliary voltage from an available DC voltage, a second voltage regulating circuit for generating a first supply voltage for the controller from the auxiliary voltage, and a third voltage regulating circuit for generating a second supply voltage for the driver circuit from the auxiliary voltage. The third voltage regulating circuit generates the second supply voltage in a manner dependent on a control signal from the controller. Alternatively, the third voltage regulating circuit is suitable for generating a second supply voltage for the driver circuit from the first supply voltage for the controller, wherein the third voltage regulating circuit generates the second supply voltage in a manner dependent on a control signal from the controller.

In the case of this circuit configuration, first an auxiliary voltage is generated from an available DC voltage by a first voltage regulating circuit. The potential of the auxiliary voltage can be configured, with regard to the power loss, optimally, for the peripheral components, which usually have a constant current consumption.

The generation of the first supply voltage for the controller (e.g. microcontroller) by the second voltage regulating circuit from the auxiliary voltage can be carried out with relatively low losses since the voltage difference between the auxiliary voltage and the first supply voltage can be chosen to be relatively small.

The second supply voltage for the driver circuit is likewise generated from the auxiliary voltage by the third voltage regulating circuit. Since the third voltage regulating circuit generates the second supply voltage for the driver circuit in a manner dependent on a control signal from the controller, the second supply voltage is generated, in particular, only when it is actually required by the driver circuit.

In this way, it is possible to reduce the power loss of the circuit configuration in standby in comparison with conventional circuit configurations wherein the supply voltage for the driver circuit is continuously generated. Moreover, it is possible to avoid incorrect driving of the components driven by the driver circuit for example in standby or during the initialization of the controller.

The second voltage regulating circuit has a series regulator, for example.

In one configuration of the invention, the second supply voltage is chosen to be greater than or equal to the auxiliary voltage. In this case, the third voltage regulating circuit has, for example, a boost controller and/or a charge pump.

In an alternative configuration of the invention, the second supply voltage is chosen to be less than or equal to the auxiliary voltage. In this case, the third voltage regulating circuit has a buck controller, for example.

In yet another configuration of the invention, the controller is configured in such a way that it generates the control signal for the third voltage regulating circuit in a manner dependent on a fault-free functionality of the driver circuit and/or a circuit driven by the driver circuit. In this way, it is possible to realize a so-called watchdog function with the circuit configuration according to the invention in a simple manner and, in particular, without additional circuits or components.

Furthermore, the magnitude of the second supply voltage for the driver circuit can optionally be controllable by the controller itself or by an additional circuit.

In a further configuration of the invention, the circuit configuration furthermore has an intermediate circuit for providing the DC voltage, the intermediate circuit being connectable to a voltage source.

The intermediate circuit can contain a rectifier circuit, for example.

In the method according to the invention for providing a voltage supply for a driver circuit driven by a controller, an auxiliary voltage is generated from an available DC voltage; a first supply voltage for the controller is generated from the auxiliary voltage; and a second supply voltage for the driver circuit is generated from the auxiliary voltage in a manner dependent on a control signal from the controller. Alternatively, the second supply voltage is fed from the first supply voltage.

Preferably, the above-described circuit configuration of the invention is used for carrying out this method for providing the voltage supply for the driver circuit.

The above-described circuit configuration and the above-described method according to the present invention can advantageously be used for driving motor drives. In particular they are also suitable for motor drives in electronic domestic appliances such as, for example, washing machines, tumble dryers, dishwashers and the like.

The electronic circuit components “intermediate circuit”, “series regulator”, “boost controller”, “buck controller”, “charge pump” and the like are sufficiently known to the person skilled in the art with regard to construction and functioning. In this regard, the present invention is intended not to be restricted to specific embodiments of these components.

Other features which are considered as characteristic for the invention are set forth in the appended claims.

Although the invention is illustrated and described herein as embodied in a circuit configuration and a method for providing a voltage supply for a driver circuit, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic illustration of a circuit configuration in accordance with a first exemplary embodiment according to the invention;

FIG. 2 is a schematic illustration of the circuit configuration in accordance with a second exemplary embodiment according to the invention; and

FIG. 3 is a schematic illustration of a driving of a driver circuit for the circuit configurations in FIGS. 1 and 2.

### DETAILED DESCRIPTION OF THE INVENTION

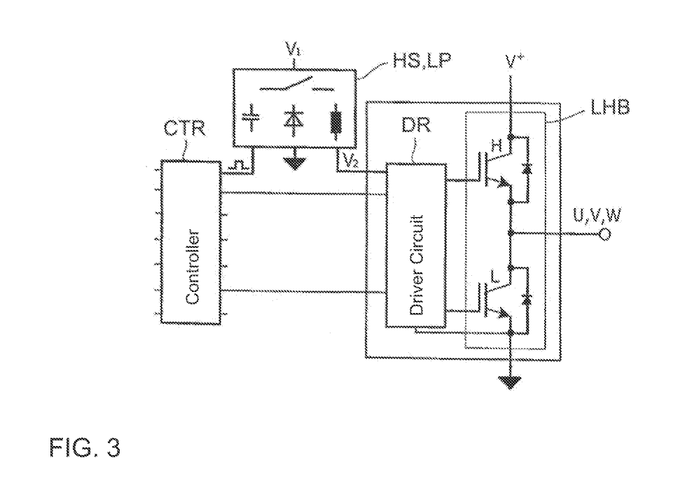

Referring now to the figures of the drawing in detail and first, particularly, to FIGS. 1 and 3 thereof, there is shown a first exemplary embodiment of a circuit configuration for providing a supply voltage for a driver circuit will now be explained in greater detail.

As illustrated in FIG. 3, a controller CTR, for example a microcontroller, drives a driver circuit DR. The driver circuit DR, in turn, switches the power semiconductor switches of a power semiconductor bridge LHB of a motor (e.g. drive motor of a laundry drum of a washing machine or of a tumble dryer).

While the motor windings are supplied, via the power semiconductor bridge LHB, with a DC voltage V+ made available by an intermediate circuit, for example, as explained later, the driver circuit DR requires a supply voltage V2 of approximately 15 V, for example. As explained below with reference to FIG. 1, the supply voltage V2 is generated only as necessary by a voltage regulating circuit HS or LP, which is driven by the controller CTR.

Referring now to FIG. 1, the intermediate circuit voltage V+, which is generated by an intermediate circuit ZK, serves as voltage source for all of the loads. The intermediate circuit ZK is connectable to a mains system LN and has a rectifier circuit and an intermediate circuit capacitor in order to generate the intermediate circuit voltage V+ by rectifying the mains system voltage.

An auxiliary voltage V1 having the magnitude of 5.5 V, for example, is then generated from the intermediate circuit voltage V+ by a first voltage regulating circuit in the form of a conventional buck controller TS. The auxiliary voltage V1 directly supplies the various peripheral components (e.g. operational amplifiers, comparators, communication, drivers, etc.).

In addition, the auxiliary voltage V1 serves as a source for a first supply voltage V3 for the microcontroller CTR having a magnitude of 3.3 V, for example. The first supply voltage V3 for the controller CTR is generated very accurately from the auxiliary voltage V1 with the aid of a second voltage regulating circuit in the form of a series regulator LR.

The auxiliary voltage V1 provided by the buck controller TS additionally serves as a source for a second supply voltage V2 for the driver circuit having a magnitude of 15 V, for example. In this exemplary embodiment, the second supply voltage V2 is generated from the auxiliary voltage V1 by a third voltage regulating circuit in the form of a boost controller HS.

As illustrated in FIG. 1, the boost controller HS contains an inductance L, a diode D and a transistor Q. In order to generate a second supply voltage V2 that is higher than the auxiliary voltage V1, the transistor Q of the boost controller HS is driven with a high-frequency rectangular signal. The greater the frequency of the rectangular signal, the smaller the dimensions with which the inductance of the boost controller HS can be embodied.

The rectangular signal for the transistor Q of the boost controller HS (the control signal of the invention) is generated by the microcontroller CTR. In this case, the controller CTR drives the boost controller HS only if the driver circuit DR is intended to drive the power semiconductor bridge LHB and if a fault-free program flow is present in the CTR. This means that the generation of the rectangular signal is only possible if the cyclic software-side program processing in the CTR has no faults and all external conditions are met. A watchdog function is thereby fulfilled at the same time. It is thereby possible to prevent incorrect driving of the power semiconductor bridge LHB for example in standby or during the initialization of the microcontroller. In addition, a so-called watchdog function can be realized in this way without additional circuits and components.

The regulation of the desired voltage magnitude of the second supply voltage V2 for the driver circuit DR can be effected for example “externally” by a comparator circuit. The latter compares the output voltage via a corresponding voltage divider with a reference value and locks the control signal of the microcontroller CTR in the case where the predefined reference value is exceeded. If the reference value is then undershot again with a hysteresis, the control signal of the microcontroller CTR is again “allowed through” to the transistor Q of the boost controller HS.

Alternatively, the regulation of the magnitude of the second supply voltage V2 can also be performed by the microcontroller CTR itself. In this case, by way of example, the generated voltage is fed back via a corresponding voltage divider to the microcontroller CTR in order to enable or block the control signal by an internal logic of the microcontroller CTR.

If no control signal is supplied to the boost controller HS by the controller CTR, the second supply voltage V2 for the driver circuit DR is approximately at the potential of the auxiliary voltage V1 minus the forward voltage of the diode D of the boost controller HS. This reduced second supply voltage does not suffice, however, to drive the power semiconductor bridge LHB since the driver circuit DR typically has an undervoltage shutdown.

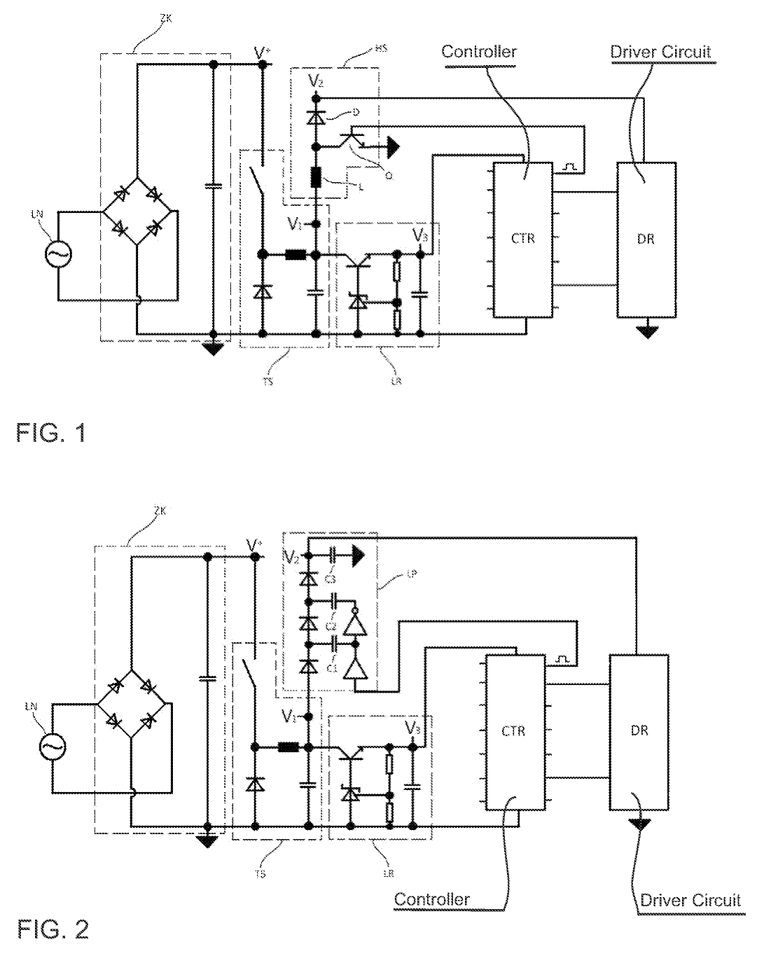

FIG. 2 shows a second exemplary embodiment of a circuit construction for providing a supply voltage for the driver circuit DR from FIG. 3. In this case, identical or analogous components are provided with the same reference symbols as in FIG. 1.

In this exemplary embodiment, the third voltage regulating circuit is realized by a charge pump LP. The charge pump LP has three series-connected diodes, three capacitors C1, C2 and C3, an amplifier gate and an inverting gate. The control signal from the microcontroller CTR connects the capacitors C1 and C2 to the auxiliary voltage V1 or to earth alternately and in an inverted fashion by means of the amplifier and inverting gates. This results in charge transport to the third capacitor C3 of the charge pump LP, at a voltage V2 three times higher than the auxiliary voltage V1.

In this embodiment, too, the magnitude of the second supply voltage V2 for the driver circuit DR, analogously to the first exemplary embodiment, can optionally be regulated by the microcontroller CTR itself or by an “external” circuit.

The remaining components and the modes of functioning thereof correspond to those of the first exemplary embodiment above.

While in the two abovementioned exemplary embodiments in FIGS. 1 and 2, the second supply voltage V2 for the driver circuit DR is in each case chosen to be greater than the auxiliary voltage V1 generated from the intermediate circuit voltage V+ by the buck controller TS and is accordingly increased from 5.5 V to 15 V, for example, by a boost controller HS or a charge pump LP as the third voltage regulating circuit, there is also the possibility, in principle, of choosing the second supply voltage V2 for the driver circuit DR to be less than the auxiliary voltage V1 generated from the intermediate circuit voltage V+ by the buck controller TS and accordingly of decreasing the second supply voltage by a buck controller as the third voltage regulating circuit.

1. A circuit configuration for providing a voltage supply for a driver circuit, the circuit configuration comprising:
a controller for driving the driver circuit and outputting a control signal;
a first voltage regulating circuit for generating an auxiliary voltage from an available DC voltage;
a second voltage regulating circuit for generating a first supply voltage for said controller from the auxiliary voltage; and
a third voltage regulating circuit for generating a second supply voltage for the driver circuit from the auxiliary voltage or the first supply voltage for said controller, said third voltage regulating circuit generating the second supply voltage in a manner dependent on the control signal from said controller.

2. The circuit configuration according to claim 1, wherein said second voltage regulating circuit has a series regulator.

3. The circuit configuration according to claim 1, wherein:
the second supply voltage is greater than or equal to the auxiliary voltage; and
said third voltage regulating circuit has at least one of a boost controller or a charge pump.

4. The circuit configuration according to claim 1, wherein:
the second supply voltage is less than or equal to the auxiliary voltage; and
said third voltage regulating circuit has a buck controller.

5. The circuit configuration according to claim 1, wherein said controller is configured such that it generates the control signal for said third voltage regulating circuit in a manner dependent on a fault-free functionality of at least one of the driver circuit or a circuit driven by the driver circuit.

6. The circuit configuration according to claim 1, wherein a magnitude of the second supply voltage for the driver circuit is controllable by said controller.

7. The circuit configuration according to claim 1, further comprising an intermediate circuit for providing the available DC voltage, said intermediate circuit being connectable to a voltage source.

8. The circuit configuration according to claim 7, wherein said intermediate circuit contains a rectifier circuit.

9. The circuit configuration according to claim 1, further comprising an additional circuit, a magnitude of the second supply voltage for the driver circuit is controllable by said additional circuit.

10. A method for providing a voltage supply for a driver circuit driven by a controller, which comprises the steps of:
generating an auxiliary voltage from an available DC voltage;
generating a first supply voltage for the controller from the auxiliary voltage; and
generating a second supply voltage for the driver circuit from the auxiliary voltage or the first supply voltage in a manner dependent on a control signal from the controller.

11. The method according to claim 10, which further comprises providing a circuit configuration having the controller for driving the driver circuit and outputting the control signal, the circuit configuration further containing:
a first voltage regulating circuit for generating the auxiliary voltage from the available DC voltage;
a second voltage regulating circuit for generating the first supply voltage for said controller from the auxiliary voltage; and
a third voltage regulating circuit for generating the second supply voltage for the driver circuit from the auxiliary voltage or the first supply voltage for the controller, the third voltage regulating circuit generating the second supply voltage in a manner dependent on the control signal from said controller.
